(19) United States
(12) Patent Application Publication
(10) Pub. No.: US 2026/0313391 A1
(43) Pub. Date: Oct. 8, 2026

(54) INTERFACE FOR PARTITIONING BASEBAND NETWORK FUNCTIONS

(71) Applicant: Telefonaktiebolaget LM Ericsson (PUBL), Stockholm (SE)

(72) Inventors: Christopher RICHARDS, OTTAWA (CA); Jose DURAN, Ottawa (CA); Haseeb AKHTAR, GARLAND, TX (US)

(21) Appl. No.: 19/475,803

(22) PCT Filed: Apr. 18, 2024
(86) PCT No.: PCT/IB2024/053803

§ 371 Date: Oct. 16, 2025

Related U.S. Application Data
(60) Provisional application No. 63/496,864, filed on Apr. 18, 2023.

(51) Int. Cl. H04W 24/02

(52) U.S. Cl. CPC H04W 24/02

(57) ABSTRACT

According to some embodiments, a method is performed by an open distributed unit (O-DU) network node with a High-Phy acceleration abstraction layer (AALI-P) interface. The method comprises requesting a transfer of O1 interface configuration data elements from an O-DU acceleration abstraction layer (AAL) application and receiving O1 interface configuration data elements from the O-DU AAL application.

### TECHNICAL FIELD

Embodiments of the present disclosure are directed to wireless communications and, more particularly, to an interface for partitioning baseband network functions.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The hardware acceleration of layer-1 (i.e., physical layer or PHY) functions is a known technology. Open Radio Access Network (O-RAN) Alliance has been working to standardize the Acceleration Abstraction Layer (AAL) between the radio access network (RAN) software functions and the accelerator. See RAN Working Group 6 O-RAN Acceleration Abstraction Layer; General Aspects and Principles TS; O-RAN.WG6.AAL-GAnP-R003-v05.00.docx; O-RAN Alliance; December 2022. The current O-RAN standard supports offloading the forward error correction (FEC) function to an accelerator using the ‘look-aside’ approach. See O-RAN Working Group 6 Acceleration Abstraction Layer FEC Profiles; O-RAN.WG6.AAL-FEC.0-v03.00.docx; O-RAN Alliance; December 2022. Discussion is ongoing to offload the entire open distributed unit (O-DU) layer-1 (or High PHY) function to an accelerator using the ‘inline’ approach. See O-RAN Working Group 6 O-RAN Acceleration Abstraction Layer High-PHY Profiles TS; O-RAN.WG6.AAL-HI_PHY-R003-v04.00.zip; O-RAN Alliance; December 2022.

The O-RAN interface between the open distributed unit (O-DU) upper functions (AAL Application) and O-DU Layer-1 (or High PHY), however, has not been specified.

There currently exist certain challenges. For example, the current technology does not address an open and multiple-vendor interface across the O-DU upper functions and the O-DU High-Phy in O-RAN O-DU network functions. As shown in FIG. 1, O-RAN has specified several interfaces and functions that are not present in other technology standards. Therefore, existing layer two (L2) to layer one (L1) interfaces have not considered the requirements for these O-RAN specific interfaces and functions.

### SUMMARY

As described above, certain challenges currently exist with open radio access network (O-RAN) interfaces. Certain aspects of the present disclosure and their embodiments may provide solutions to these or other challenges. For example, particular embodiments described herein define the interface between the upper open distributed unit (O-DU) functions and O-DU Layer-1 within an O-DU RAN function. This is referred to as the High-Phy acceleration abstraction layer interface (AALI-P) profile specific interface. A specialization of the High-Phy AALI-P interface is for the inline High-Phy interface profile. This interface is applicable to implementations where the O-DU Layer-1 may be implemented in specialized hardware or software or a mixture of the two when using the inline architecture as shown in FIG. 2. A further specialization is when the High-Phy AALI-P interface is for the High-Phy look-aside profile.

The embodiments described herein focus on the changes to the existing O-RAN interfaces and standards (O-RAN Working Group 1 (Use Cases and Overall Architecture O-RAN Architecture Description; O-RAN.WGI.OAD-R003-v09.00.docx; O-RAN Alliance; March 2023) due to the introduction of such a High-Phy AALI-P interface. Examples described include coordination with the O-RAN LLS CUS (O-RAN Working Group 4 (Open Fronthaul Interfaces WG) Control, User and Synchronization Plane Specification; O-RAN.WG4.CUS.0-R003-v12.00.docx; O-RAN Alliance; December 2022) and M-Plane interfaces (O-RAN Working Group 4 (Open Fronthaul Interfaces WG) Management Plane Specification; O-RAN.WG4.MP.0-v11.00.docx; O-RAN Alliance; December 2022), O-RAN synchronization realizations (O-RAN Working Group 6 (Cloudification and Orchestration) Cloud Architecture and Deployment Scenarios for O-RAN Virtualized RAN; O-RAN.WG6.CADS-v04.00-final.pdf, O-RAN Alliance; December 2022) and the O-RAN O1 interface (O-RAN Operations and Maintenance Interface Specification; O-RAN.WG10.01-Interface.0-R003-v10.00.docx; O-RAN Alliance; December 2022).

FIG. 1 is a block diagram illustrating O-RAN network architecture with existing O-RAN and 3GPP interfaces (O-RAN Working Group 1 (Use Cases and Overall Architecture) O-RAN Architecture Description; O-RAN.WG1.OAD-R003-v09.00.docx; O-RAN Alliance; March 2023). The 3GPP interfaces include E1, X2-c, X2-u, NG-u, Xn-u, Xn-c, NG-c, F1-u and F1-c. The O-RAN interfaces include) A1, E2, O1, O2, Y1, Open FH M-Plane and Open FH CUS-Plane.

Other specifications have described a general Layer-2 and Layer-1 interface for 3GPP based RAN functions. For example, the Small Cell Forum FAPI and nFAPI specifications (SCF222_5G-FAPI_PHY_SPI_Specification-JULY-22; Small Cell Forum FAPI SCF222, July 2022; SCF225_5G_nFAPI_specification-JULY-22; Small Cell Forum FAPI SCF222, July 2022). There are several open implementations supporting a 3GPP Layer-2 and Layer-1 interface including Open Air Interface (OAI) (See www.openairinterface.org).

However, these specifications and implementations do not consider O-RAN specific interfaces, functions, and capabilities. Particular embodiments described herein are related to the impacts of defining new inline High-Phy AALI-P and look-aside High-Phy AALI-P interfaces to existing O-RAN specific interfaces.

FIG. 2 illustrates the ‘look-aside’ and ‘inline’ acceleration methods. As illustrated, in the look-aside method the High PHY processing is handled by the central processing unit (CPU), which offloads either certain parts of the overall High-Phy to an accelerator while returning control towards the open front haul (OFH) to the CPU, while in the inline method the accelerator handles the High-Phy processing and the connectivity to the OFH.

In general, particular embodiments define an O-RAN interface (AALI-P) between the O-DU upper layers (e.g., L2 user and control planes, O-DU internal OAM functions) and L1 (O-DU High-Phy) of the O-DU RAN function by including the following data (both in uplink and downlink).

Two specific variants of the AALI-P interface are applicable: inline High-Phy AALI-P and look-aside High-Phy AALI-P.

Inline High-Phy AALI-P is the interface variant used when the accelerated functions in the AAL includes both the High-Phy functions and the OFH network interface connection, e.g., the OFH Ethernet network interface card (NIC) connecting to the O-RU(s) is physically part of the device hosting the O-RAN AAL inline High-Phy function.

FIG. 3 illustrates the architecture and AALI-P for the inline High-Phy profile. Look-aside High-Phy AALI-P is the interface variant used when the device is hosting the O-RAN AAL inline High-Phy functions but not the OFH network interface connection, e.g., the OFH Ethernet NIC connecting to the O-RU(s) is not physically part of the device hosting the O-RAN AAL High-Phy function, as illustrated in FIG. 4.

FIG. 4 illustrates the AALI-P for look-aside acceleration for the complete High-Phy. Some of the embodiments described below are applicable to both interface variants, while others are applicable to only one interface variant.

Particular embodiments define the behavior and capabilities of new O-RAN inline High-Phy AALI-P and look-aside High-Phy AALI-P interface signaling between an O-RAN O-DU network function (Internal O-DU OAM and L2 functions) and a function providing O-DU layer (High-Phy) acceleration and OFH network connectivity functions.

Particular embodiments define inline High-Phy AALI-P signaling between the O-DU internal O1 OAM function and the High-Phy to support O1 configuration and data collection via the inline High-Phy AALI-P interface.

Particular embodiments define inline High-Phy AALI-P signaling between the O-DU internal M-Plane OAM function and the inline High-Phy to support M-Plane configuration via the inline High-Phy AALI-P interface.

Particular embodiments define inline/look-aside High-Phy AALI-P signaling between the O-DU internal synchronization management function and the device hosting the inline/look-aside High-Phy function to support synchronization modes and states via the inline/look-aside High-Phy AALI-P interface.

Particular embodiments define AALI-P signaling between the O-DU user plane function and the inline/look-aside High-Phy to support reporting and configuration of High-Phy processing timing budgets via the inline/look-aside AALI-P interface.

Particular embodiments define capabilities for enabling and disabling the use of a specific inline/look-aside High-Phy network function instance without disturbing the cell(s) using the specific High-Phy network function instance served by the O-DU.

Particular embodiments define a method in the inline/look-aside High-Phy AALI-P interface to query and select an OFH control user synchronization (CUS) version to be used by an inline/look-aside High-Phy function.

Particular embodiments define a method in the inline/look-aside High-Phy AALI-P to exchange data elements for O-DU features that have dependencies across the inline/look-aside High-Phy AALI-P interface, for example carrier aggregation, coordinated multi-point, shared O-RU, etc.

According to some embodiments, a method is performed by an O-DU network node with a High-Phy AALI-P interface. The method comprises requesting a transfer of O1 interface configuration data elements from an O-DU AAL application and receiving O1 interface configuration data elements from the O-DU AAL application.

In particular embodiments, the method further comprises transferring O1 interface measurement data elements to the O-DU AAL application. Transferring O1 interface measurement data elements may be initiated upon request, sent at defined time intervals, or may be continually streamed.

In particular embodiments, the method further comprises transferring O1 interface fault and alarm notifications and associated data elements to the O-DU AAL application.

In particular embodiments, the method further comprises requesting a transfer of M-plane data from the O-DU AAL application and receiving M-plane data from the O-DU AAL application.

In particular embodiments, the method further comprises transferring an M-plane status signal to the O-DU AAL application. The M-plane status signal may comprise one or more of: a configuration status; a status of a connected O-RU; a status of a connected OFH; a format of M-plane data supported by the AALI-P; and a version of M-plane data supported by the AALI-P.

In particular embodiments, the method further comprises receiving OFH configuration data from the O-DU AAL application.

In particular embodiments, the method further comprises transmitting, to the O-DU AAL application, an indication of a latest time that downlink user and control plane data can be received to be transmitted over the air for a next slot.

In particular embodiments, the method further comprises transmitting, to the O-DU AAL application, an indication of a latest time that uplink user and control plane data shall be transmitted to upper protocol layers after processing.

In particular embodiments, the method further comprises receiving, from the O-DU AAL application, an indication of a desired latest reception time of processed user and control plane data.

In particular embodiments, the method further comprises providing one or more of time synchronization and frequency synchronization for a connected O-RU.

In particular embodiments, the method further comprises receiving, from the O-DU AAL application, an indication of a synchronization source to use for a connected O-RU.

In particular embodiments, the method further comprises receiving a request for hybrid automatic repeat request (HARQ) information from the O-DU AAL application; and transferring HARQ information to the O-DU AAL application.

In particular embodiments, the method further comprises receiving) a request for radio access network intelligent controller (RIC) information from the O-DU AAL application and transferring RIC information to the O-DU AAL application.

According to some embodiments, a network node network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, in particular embodiments the AALI-P interfaces enable a multiple-vendor open interface between the O-DU upper layers and O-DU High-Phy of any O-RAN O-DU network function.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating open radio access network (O-RAN) network architecture with existing O-RAN and Third Generation Partnership Project (3GPP) interfaces;

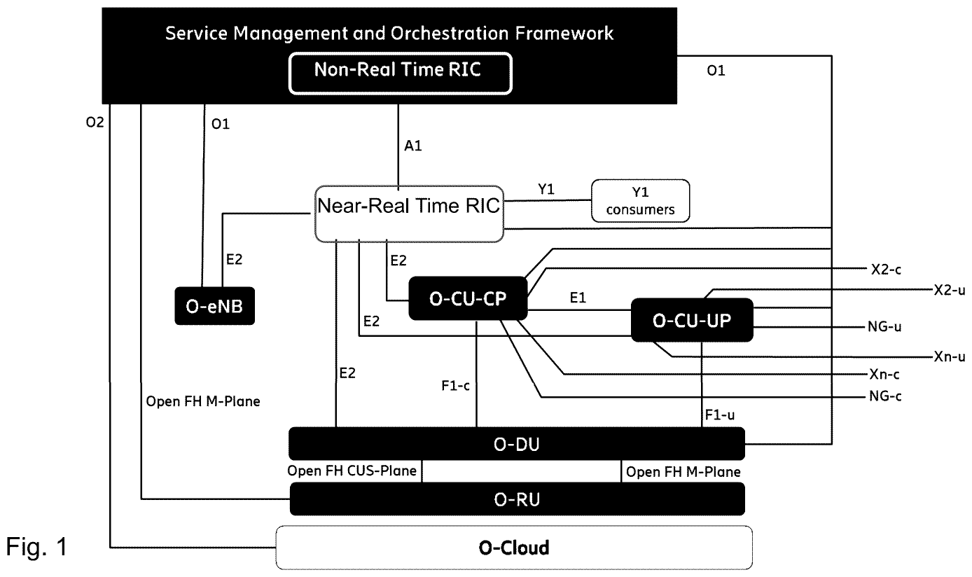

FIG. 2 illustrates the ‘look-aside’ and ‘inline’ acceleration methods;

FIG. 3 illustrates the architecture and accelerator abstraction layer (AAL) interface (AALI-P) for the inline High-Phy profile;

FIG. 4 illustrates the AALI-P for look-aside acceleration for the complete High-Phy;

FIG. 5 is a block diagram illustrating O-RAN AAL high-level architecture and the interfaces AALI-C-Mgmt, AALI-C-App and AALI-P;

FIG. 6 illustrates a different architecture and view of the O-RAN interfaces of the O-DU, open radio unit (O-RU) and inline High-Phy;

FIG. 7 is a block diagram illustrating a high level view of the scope for the AALI-P interface;

FIG. 8 illustrates the scope of AALI-P with support from open front haul (OFH) M-Plane and O1 interfaces in AALI-P;

FIG. 9 illustrates the scope of AALI-P with support from OFH S-Plane and OFH CU-Plane interfaces in AALI-P;

FIG. 10 illustrates support of general requirements in AALI-P;

FIG. 11 illustrates an example communication system, according to certain embodiments;

FIG. 12 illustrates an example user equipment (UE), according to certain embodiments;

FIG. 13 illustrates an example network node, according to certain embodiments;

FIG. 14 illustrates a block diagram of a host, according to certain embodiments;

FIG. 15 illustrates a virtualization environment in which functions implemented by some embodiments may be virtualized, according to certain embodiments;

FIG. 16 illustrates a host communicating via a network node with a UE over a partially wireless connection, according to certain embodiments; and

FIG. 17 illustrates a method performed by a network node, according to certain embodiments.

### DETAILED DESCRIPTION

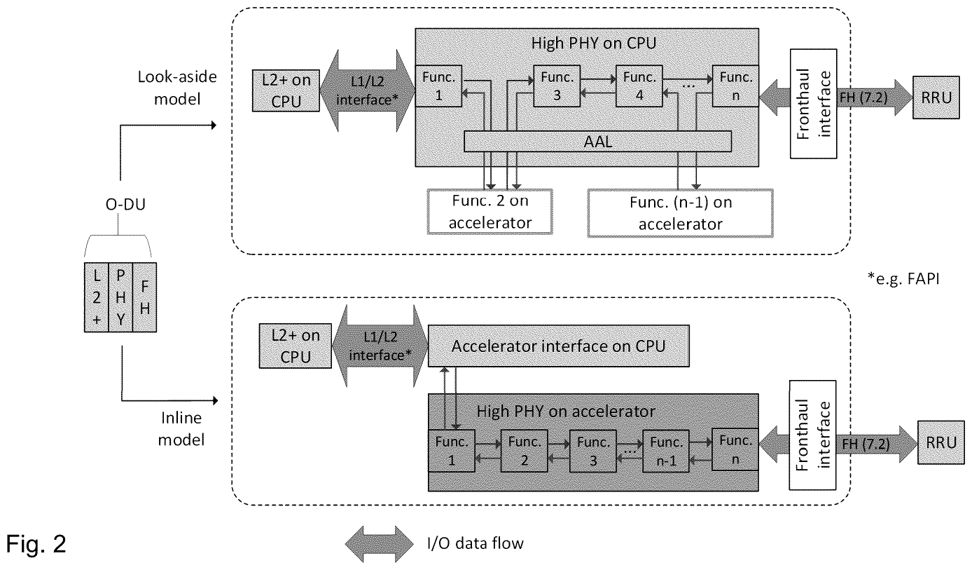

As described above, certain challenges currently exist with open radio access network (O-RAN) interfaces. Certain aspects of the present disclosure and their embodiments may provide solutions to these or other challenges. For example, particular embodiments described herein define the interface between the upper open distributed unit (O-DU) functions Layer 2 and O-DU Layer-1 including the High Phy within an O-DU RAN function. This interface may be used for High-Phy acceleration leveraging the accelerator abstraction layer interface (AALI-P) for the High Phy acceleration profile. A specialization of the High-Phy AALI-P interface is the inline High-Phy AALI-P interface. This interface is applicable to implementations where the O-DU Layer-1 may be implemented using the inline acceleration method as described in FIG. 2 with specialized hardware or software or a mixture of the two.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

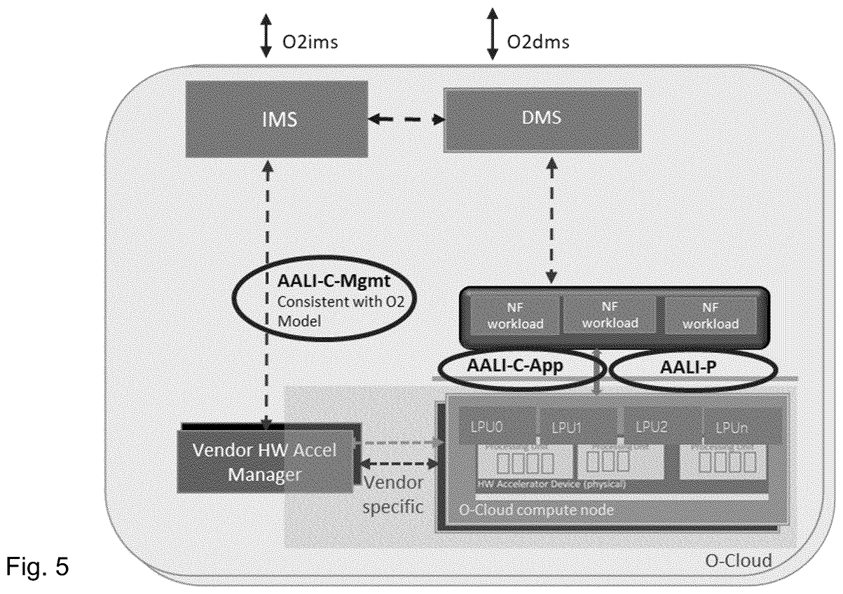

FIG. 5 illustrates the O-RAN Acceleration Abstraction Layer (AAL) architecture and the interfaces AALI-C-Mgmt, AALI-C-App and AALI-P. FIG. 5 illustrates the AALI-P interface in relation to the O-DU network function (NF) described as a workload (AAL Application) and separated from the accelerated High-Phy function. The separated High-Phy function may be implemented in a hardware accelerator (HWA) (as defined in O-RAN Working Group 6 O-RAN Acceleration Abstraction Layer; General Aspects and Principles TS; O-RAN.WG6.AAL-GAnP-R003-v05.00.docx; O-RAN Alliance; December 2022), or as a cloud function, but is not limited to a hardware implementation or hardware acceleration.

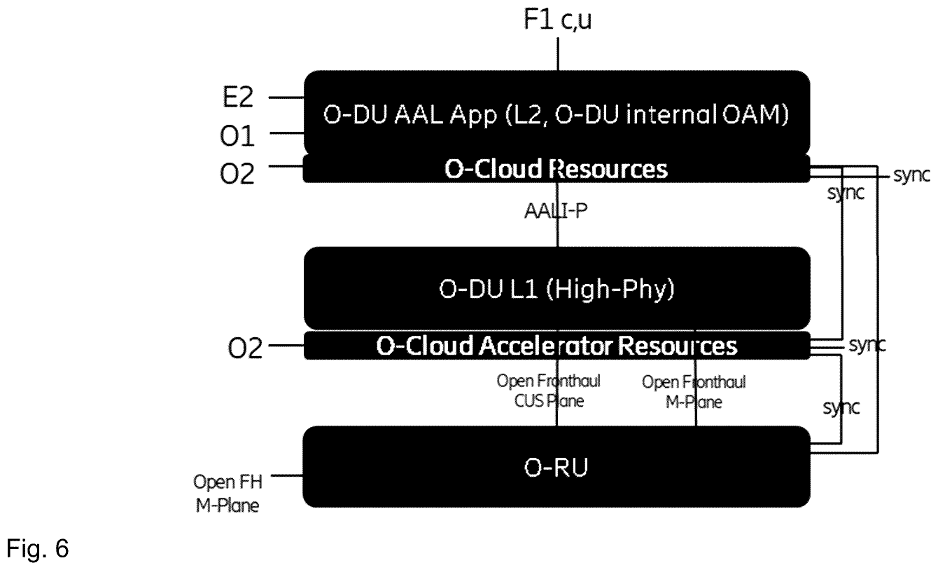

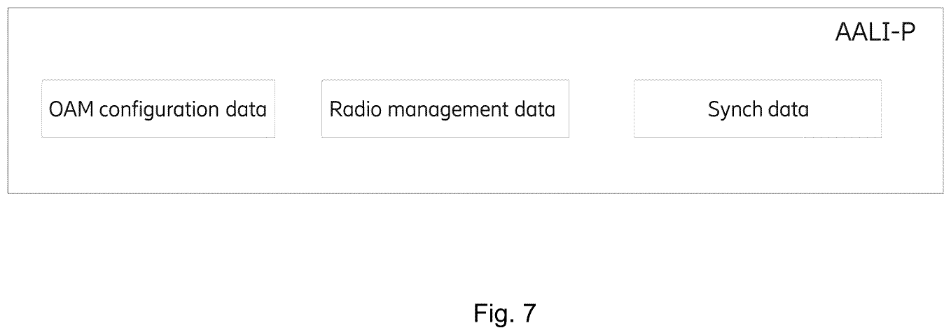

FIG. 6 illustrates an architecture and interfaces for the O-DU, O-RU when using inline High-Phy acceleration. The O-DU network function and O-DU L1 (High-Phy) are hosted on O-Cloud resources that provide compute and networking capabilities. The AALI-P connectivity may be provided by a PCIe connection, or an Ethernet connection as described in O-RAN Working Group 6 O-RAN Acceleration Abstraction Layer; General Aspects and Principles TS; O-RAN.WG6.AAL-GAnP-R003-v05.00.docx; O-RAN Alliance; December 2022. FIG. 7 illustrates one breakdown of the O-RAN O-DU AAL Application, and the interconnection with O-RU and O-DU High-Phy when using the inline High-Phy AALI-P, M-Plane, O1, open front haul (OFH) control user synchronization (CUS) interfaces.

Particular embodiments enable the AALI-P interface (e.g., inline High-Phy AALI-P, High-Phy AALI-P) to convey data and information elements relating to the M-Plane, O1, E2 and synchronization interfaces between the AAL Application and the High-Phy.

FIG. 7 illustrates a high level view of the scope of the AALI-P interface for High-Phy profile.

Particular embodiments include inline High-Phy AALI-P interface support for O-RAN O1 interface and data collection.

O1-1: The inline High-Phy AALI-P interface shall support the transfer of High-Phy related O1 and radio unit (RU) configuration data elements (O-RAN Operations and Maintenance Interface Specification; O-RAN.WG10.01-Interface.0-R003-v10.00.docx; O-RAN Alliance; December 2022) from the O-DU AAL Application (e.g., an O-DU internal O1 OAM function) to the High-Phy.

O1-2: The look-aside High-Phy AALI-P interface shall support the High-Phy the transfer of High-Phy related O1 configuration data elements (O-RAN Operations and Maintenance Interface Specification; O-RAN.WG10.01-Interface.0-R003-v10.00.docx; O-RAN Alliance; December 2022) from the O-DU AAL Application (e.g., an O-DU internal O1 OAM function) from the O-DU AAL Application (e.g., from an O-DU internal O1 OAM function) to the High-Phy.

O1-3: The inline High-Phy AALI-P and look-aside High-Phy AALI-P interfaces shall support the transfer of O1 High-Phy related measurement data elements (O-RAN Operations and Maintenance Interface Specification; O-RAN.WG10.01-Interface.0-R003-v10.00.docx; O-RAN Alliance; December 2022) from the O-DU AAL Application (e.g., an O-DU internal O1 OAM function) from the High-Phy to the O-DU AAL Application (e.g., to an O-DU internal O1 OAM function) over the inline High-Phy AALI-P and look-aside High-Phy AALI-P interfaces. [0052]01-4: The transfer of O1 High-Phy measurement data elements from the High-Phy to the O-DU AAL Application (e.g., an O-DU internal O1 OAM function) may be initiated on request by the O-DU upper layers (e.g., an O-DU internal O1 OAM function) using the inline High-Phy AALI-P and look-aside High-Phy AALI-P interfaces.

O1-5: The transfer of O1 High-Phy measurement data elements from the High-Phy to the O-DU AAL Application (e.g., an O-DU internal O1 OAM function) may be sent at defined time intervals based upon time intervals signaled by the O-DU upper layers (e.g., an O-DU internal O1 OAM function) in the inline High-Phy AALI-P and look-aside High-Phy AALI-P interface signaling.

O1-6: The transfer of O1 High-Phy measurement data elements from the High-Phy to the O-DU AAL Application (e.g., to an O-DU internal O1 OAM function) over the inline High-Phy AALI-P and look-aside High-Phy AALI-P interfaces may be continually streamed.

O1-7: The streaming configuration is based upon O1 streaming parameters that are included in inline High-Phy AALI-P and look-aside High-Phy AALI-P signaling sent by the O-DU AAL Application (e.g., an O-DU internal O1 OAM function) to the High-Phy. The streaming configuration parameters may include minimum and maximum O1 data bit rate over the AALI-P interface, minimum and maximum O1 data message rate over the inline High-Phy AALI-P or look-aside High-Phy AALI-P interface, minimum and maximum time periods between O1 data messages over the AALI-P interface. The O1 streaming parameters (O-RAN Operations and Maintenance Interface Specification; O-RAN.WG10.01-Interface.0-R003-v10.00.docx; O-RAN Alliance; December 2022) from the O-DU AAL Application (e.g., an O-DU internal O1 OAM function) may be further specified by each O1 High-Phy measurement data element or group of O1 High-Phy measurement data elements.

O1-8: The AALI-P interface shall support the transfer of O1 High-Phy fault and alarm related notifications and supporting data elements (O-RAN Operations and Maintenance Interface Specification; O-RAN.WG10.01-Interface.0-R003-v10.00.docx; O-RAN Alliance; December 2022) from the O-DU AAL Application (e.g., an O-DU internal O1 OAM function) from the High-Phy to the O-DU AAL Application (e.g., to an O-DU internal O1 OAM function) over the inline High-Phy AALI-P and look-aside High-Phy AALI-P interfaces.

O1-9: The O-RAN O1 data collection functionality and interface is not changed with the introduction of the inline High-Phy AALI-P or the look-aside High-Phy AALI-P interfaces.

Particular embodiments include signaling of O-RAN M-Plane information over the Inline High-Phy AALI-P and the look-aside High-Phy interfaces.

M1: The inline/look-aside High-Phy AALI-P interface shall transport the M-Plane data from the O-DU AAL Application (e.g., an O-DU internal M-Plane OAM function) to the inline/look-aside High-Phy device hosting the inline/look-aside High-Phy. For both hierarchical and hybrid management models, the AALI-P interface shall transport the FH configuration to the O-Cloud node hosting the High-Phy.

M2: The AALI-P interface shall support the High-Phy to request the transfer of High-Phy related M-Plane configuration data elements (O-RAN Working Group 4 (Open Fronthaul Interfaces WG) Management Plane Specification; O-RAN.WG4.MP.0-v11.00.docx; O-RAN Alliance; December 2022) (e.g., OFH configuration data) from the O-DU AAL Application (e.g., an O-DU internal M-Plane OAM function) to the High-Phy.

M3: The AALI-P interface shall support the ability for the High-Phy to send a M-Plane configuration status signal to the O-DU AAL Application (e.g., an O-DU internal M-Plane OAM function).

M4: The AALI-P interface shall support the ability of the High-Phy to signal the O-DU AAL Application (e.g., an O-DU internal M-Plane OAM function) status information regarding connected O-RU(s) or the FH transport network. For example, upon detecting an error condition of the connected O-RUs or a FH transport connectivity issue.

M5: The O-DU M-Plane shall not be impacted by the presence and use of the High-Phy AALI-P interface in the O-DU. The mechanisms supported by the O-DU M-Plane for the configuration management (CM), fault management (FM), and performance monitoring (PM) aspects of the OFH lower layer split (LLS) shall not be altered or modified whether the High-Phy AALI-P interface is used or not.

M6: The O-DU AAL Application (e.g., an O-DU internal M-Plane OAM function) shall transpose/convert the M-Plane data into a format and version that is supported by the High-Phy.

M7: The format and version of the M-Plane data that is supported by the High-Phy shall be signaled over the inline High-Phy AALI-P.

Particular embodiments include O-RAN inline High-Phy AALI-P Interface support for the OFH LLS.

M8: The inline High-Phy AALI-P interface shall support the transfer of OFH High-Phy related configuration data elements from the O-DU AAL Application (e.g., an O-DU internal OAM function) to the High-Phy. OFH High-Phy related configuration data elements include the IQ Compression scheme to use and the OFH network timing related parameters, such as OFH message transmission and reception windows (O-RAN Working Group 4 (Open Fronthaul Interfaces WG) Control, User and Synchronization Plane Specification; O-RAN.WG4.CUS.0-R003-v12.00.docx; O-RAN Alliance; December 2022).

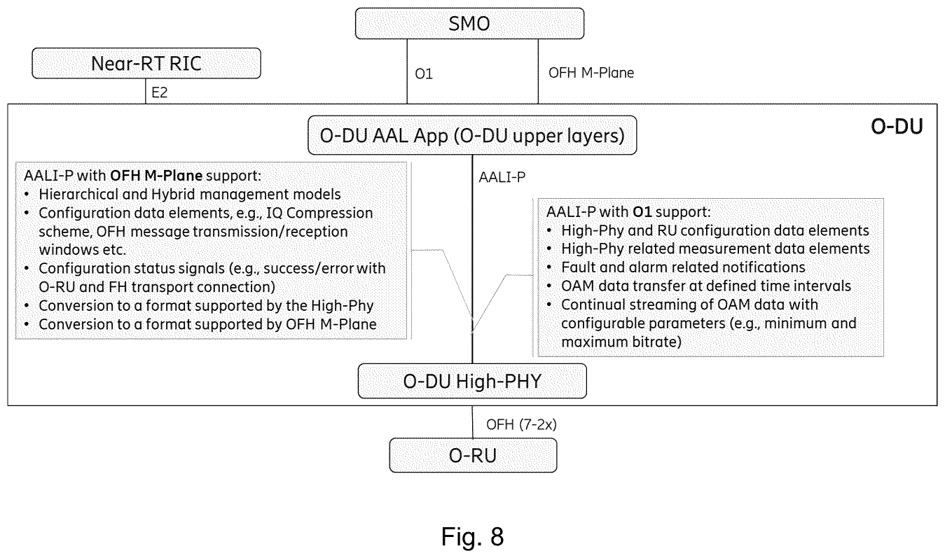

FIG. 8 illustrates the scope of the AALI-P in conjunction with the OFH M-Plane and the O1 interfaces.

Particular embodiments include allocation of O-DU User Plane processing times when an inline High-Phy AALI-P or look-aside High-Phy AALI-P interface is used.

T1: The O-RAN AALI-P interface for High-Phy defines the latest time that downlink user and control plane data can be received and processed by the High-Phy to be transmitted over the air (OTA) for the next slot. A time shall be defined for each 3GPP physical channel (e.g., physical downlink shared channel (PDSCH), physical downlink control channel (PDCCH), physical broadcast channel (PBCH), etc.), numerology and duplex scheme (e.g., frequency division duplex (FDD), time division duplex (TDD)). These times may be expressed in the number of orthogonal frequency division multiplexing (OFDM) symbols or the number of micro-seconds ahead of the OTA slot start time. The times shall be signaled from the High-Phy to the upper O-DU layers using the AALI-P interface.

T2: The O-RAN AALI-P interface for High-Phy defines the latest time that uplink user and control plane data shall be transmitted to upper protocol layers (e.g., medium access control (MAC) user plane, MAC scheduler) after processing by the High-Phy. A time shall be defined for each 3GPP physical channel (e.g., physical uplink shared channel (PUSCH), physical uplink control channel (PUCCH), sounding reference signal (SRS), physical random access channel (PRACH), etc.), in each numerology and duplex scheme (e.g., FDD, TDD). These times may be expressed in the number of OFDM symbols or the number of micro-seconds after the received OTA slot start time. The times shall be signaled from the High-Phy to the upper O-DU layers using the AALI-P interface.

T3: The O-RAN AALI-P interface shall also support signaling to the High-Phy of desired latest reception times of processed user and control plane data from the High-Phy. A time shall be defined for each 3GPP physical channel (e.g., PUSCH, PUCCH, SRS, PRACH, etc.), in each numerology and duplex scheme (e.g., FDD, TDD). These times may be expressed in the number of OFDM symbols or the number of micro-seconds after the received OTA slot start time. The times shall be signaled from the O-DU upper layers (e.g., L2 MAC scheduler) to the High-Phy using the AALI-P interface.

Particular embodiments include O-RAN synchronization plane solutions with an O-RAN inline/look-aside High-Phy AALI-P Interface. With the introduction of an open multivendor O-RAN interface between the O-DU AAL Application and the L1 High-Phy several alternative options are identified for the propagation and checking of timing and synchronization between the O-DU upper parts, the L1 High-Phy and the O-RU. These options are based on the synchronization topologies defined in O-RAN between the O-DU functions and the O-RU (O-RAN Working Group 6 (Cloudification and Orchestration) Cloud Architecture and Deployment Scenarios for O-RAN Virtualized RAN; O-RAN.WG6.CADS-v04.00-final.pdf, O-RAN Alliance; December 2022).

S1: Where the O-Cloud node hosting the AAL Application (such as the O-DU L2) and the device hosting the High-Phy coordinate to provide synchronization to the O-RU(s) via the FH, if the O-Cloud node hosting the AAL Application provides no synchronization, then the device hosting the High-Phy provides both time and frequency synchronization. If the O-Cloud node hosting the AAL Application provides time synchronization, e.g., precision time protocol (PTP) then the device hosting the High-Phy provides frequency synchronization e.g., SyncE. If the O-Cloud node hosting the AAL Application provides frequency synchronization e.g., SyncE, then the device hosting the High-Phy provides time synchronization e.g., PTP.

S2: A synchronization management function in the AAL Application controls what synchronization source (e.g., time synchronization via e.g., PTP, frequency synchronization via. e.g., SyncE) that the device hosting the inline High-Phy function provides via the FH interface to the connected O-RU(s). The synchronization management function uses the AALI-P interface to exchange synchronization management control information to the device hosting the inline High-Phy function.

S4: The synchronization management function in the O-Cloud node hosting the AAL Application can switch the synchronization source(s) between the O-Cloud node (hosting the AAL Application) and the HWA using the AALI-P interface.

S5: Where the O-Cloud node hosting the AAL Application acts as a synchronization and timing master towards the L1 High Phy, the AAL Application has additional timing, synchronization, and state management responsibilities over and above those described in O-RAN Working Group 6 O-RAN Acceleration Abstraction Layer; Common API TS; O-RAN.WG6.AAL-Common-API-03.00.docx; O-RAN Alliance; December 2022.

S6: Where the O-DU Li High Phy acts as slave to the O-Cloud node hosting the AAL Application for timing and frequency synchronization and will only be monitoring its own state and reporting any events when it operates outside of the timing and synchronization limits. The following table identifies the additional state management conditions beyond those defined in O-RAN Working Group 6 O-RAN Acceleration Abstraction Layer; Common API TS; O-RAN.WG6.AAL-Common-API-03.00.docx; O-RAN Alliance; December 2022.

TABLE 1
Node behavior during HOLDOVER and FREERUN

| O-Cloud | AAL | | | | | |
|---|---|---|---|---|---|---|
| node | Application | | | | | |
| Hosting | O-Cloud | HWA | HWA | | | |
| AAL | node Sync | Hosting L1 | Sync | O-RU | M-Plane | |
| Application | accuracy | High PHY | accuracy | state | state | Notes |
| LOCKED/ | In a limit | LOCKED/ | Out of a | LOCKED/ | Connected | Defined |
| HOLDOVER | | HOLDOVER | limit | HOLDOVER | | below |
| LOCKED/ | Out of a | LOCKED/ | In a limit | LOCKED/ | Connected | Defined |
| HOLDOVER | limit | HOLDOVER | | HOLDOVER | | below |

When in LOCKED or HOLDOVER state, the O-Cloud node hosting the AAL Application will continuously monitor the LOCKED/HOLDOVER status of the HWA and the O-RU(s) under its management. O-RU behavior remains unchanged as defined in O-RAN Working Group 6 O-RAN Acceleration Abstraction Layer; Common API TS; O-RAN.WG6.AAL-Common-API-03.00.docx; O-RAN Alliance; December 2022. However, the AAL Application will have additional timing, synchronization, and state management responsibilities.

The following describes the behavior defined for when the O-Cloud node hosting the L2 AAL Application estimates and detects an out of limit condition for its node or node hosting the L1 High Phy:

S7 The AAL Application will detect and estimate the frequency and/or time accuracy degradation of the HWA and the O-RU(s). The AAL Application monitors the HWA for any self-estimated frequency and/or time accuracy degradation by the HWA.

S8: Where the timing and synchronization sources are networked, the behavior of the synchronization management function in the AAL Application is as follows. While in the LOCKED/HOLDOVER state, the O-Cloud node hosting the AAL Application self-estimates the frequency and/or time accuracy degradation for both the HWA and the O-RUs. The O-Cloud node hosting the AAL Application monitors: (a) that the synchronization state of the O-Cloud node that it is hosted on are within the required limits; (b) the LOCKED or HOLDOVER state of the HWA and the O-RUS; and (c) the received physical layer frequency signals (PLFS) (if applicable) and PTP primary reference time clock (PRTC) quality status of the O-RUs. If the O-Cloud node hosting the AAL Application needs to transit from the LOCKED or HOLDOVER state to the FREERUN state because the PTP connection or the synchronizing network delivers unacceptable synchronization quality, the O-Cloud node hosting the AAL Application will then transit the HWA to the FREERUN state and disable the radio frequency (RF) transmission on all connected O-RU(s) until synchronization is reacquired again.

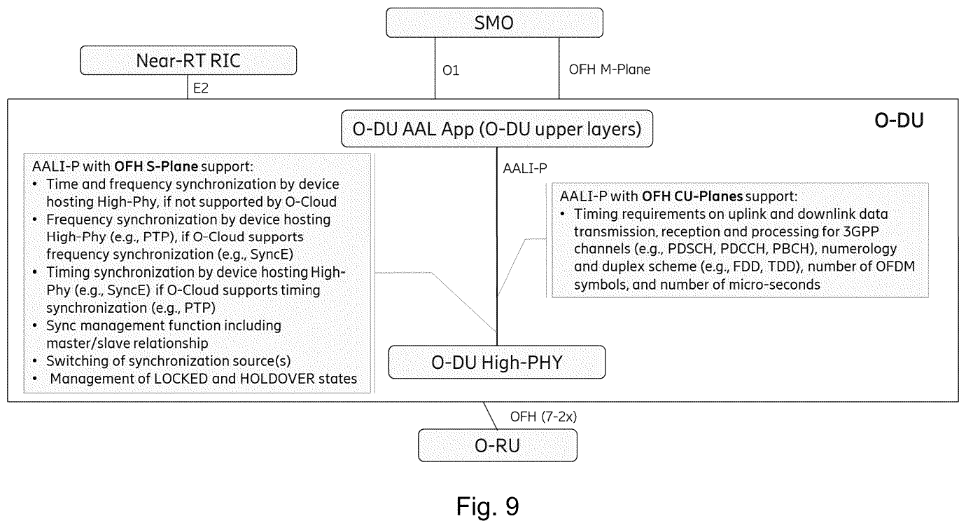

FIG. 9 illustrates the scope of the AALI-P in conjunction with the OFH S-Plane and OFH CU-Plane interfaces.

Some embodiments include additional capabilities of the inline High-Phy AALI interface.

G1: The inline High-Phy AALI-P interface and the look-aside High-Phy interface shall support signaling of a bypass mode so that the High-Phy functions are bypassed. The bypass mode indicator is applicable on a slot timing granularity, i.e., bypass mode can be changed from one slot to the next slot. The bypass mode may be set separately for different cells being served by the High-Phy function. The bypass mode may be set separately for uplink and downlink processing chains. The inline High-Phy function and the look-aside High-Phy function shall signal the state data of any ongoing hybrid automatic repeat request (HARQ) process(es) to the AAL Application (e.g., O-DU L2) using the High-Phy AALI-P interface.

The High-Phy AALI-P interface shall support requesting and retrieval of active HARQ process(es) status and data.

G2: The inline High-Phy AALI-P interface shall support querying the version(s) of the OFH CUS LLS that is supported by the inline High-Phy function.

G3: The inline High-Phy AALI-P interface shall support setting the version of the OFH CUS LLS that is to be used by the inline High-Phy function. The setting is specific for each O-RU that is connected to the O-DU.

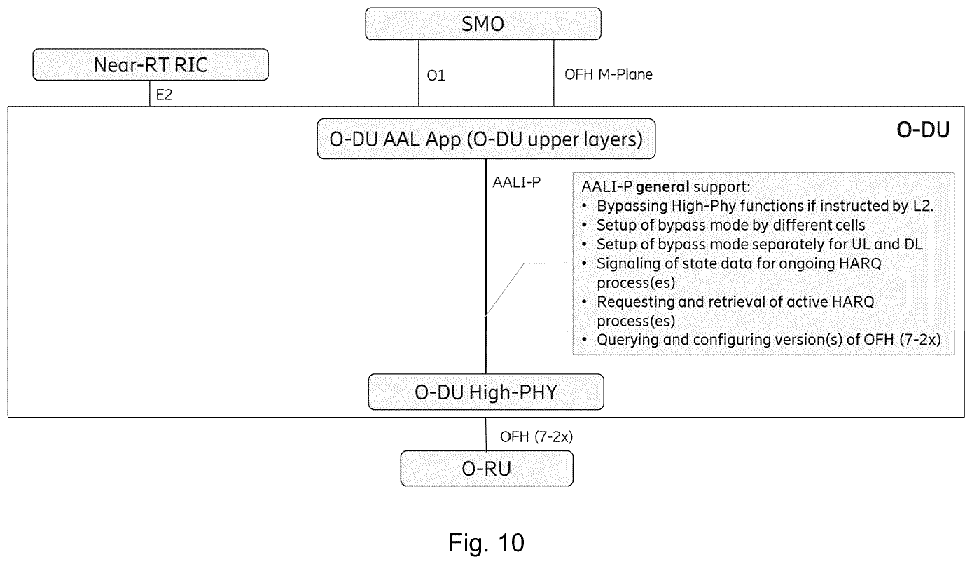

FIG. 10 illustrates support of general requirements in AALI-P.

In particular embodiments, the AALI-P interfaces (for example inline High-Phy AALI-P and look-aside High-Phy) support O-RAN E2 services and procedures (O-RAN Work Group 3 (WG-3); Near-Real-time RAN Intelligent Controller and E2 Interface; E2 General Aspects and Principles (E2GAP); O-RAN.WG3.E2GAP-R003-v03.00).

E2-1: The AALI-P interfaces (for example inline High-Phy AALI-P and look-aside High-Phy) shall include signaling to support RAN intelligent controller (RIC) procedures and services (such as E2 report, insert, control policy and query procedures) between the O-DU AAL Application (e.g., an O-DU internal E2 management function) and the O-Cloud or HWA hosting the High-Phy.

E2-2: The AALI-P interfaces (for example inline High-Phy AALI-P and look-aside High-Phy) shall support signaling between the O-DU AAL Application (e.g., an O-DU internal E2 management function) and the O-Cloud or HWA hosting the High-Phy to enable the configuration, modification and deletion of RIC subscriptions.

E2-3: The AALI-P interfaces (for example inline High-Phy AALI-P and look-aside High-Phy) shall support signaling to enable the transfer of data required for E2 report, insert, and policy services and procedures between the O-DU AAL Application (e.g., an O-DU internal E2 management function) and the O-Cloud or HWA hosting the High-Phy.

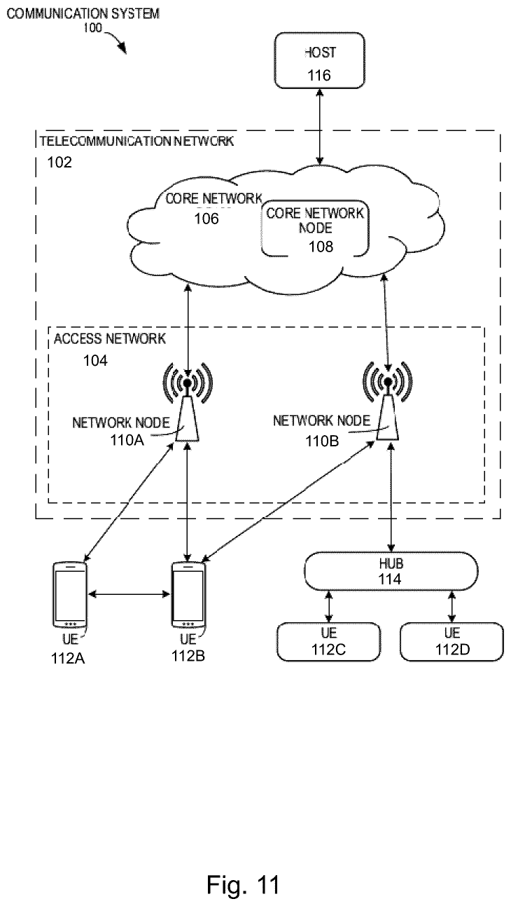

FIG. 11 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of 1 FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

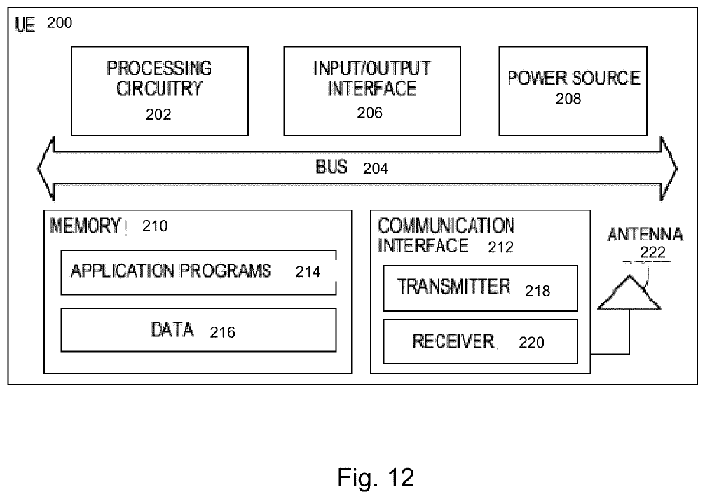

FIG. 12 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof Δn input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

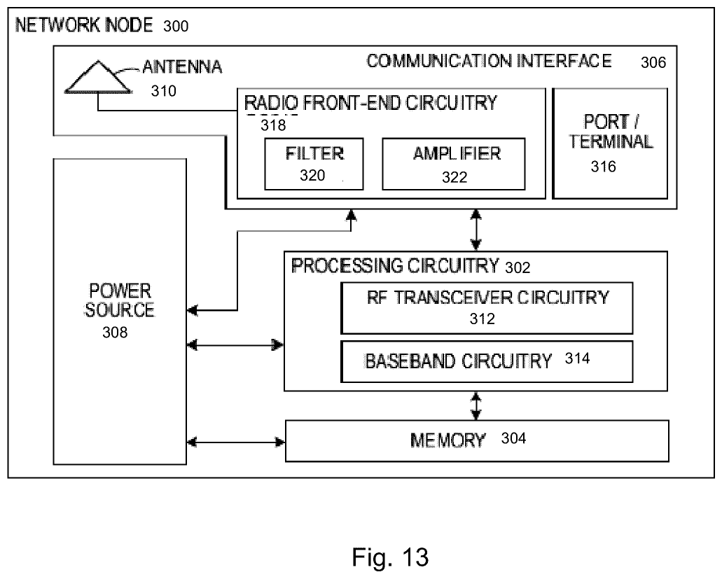

FIG. 13 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 13 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

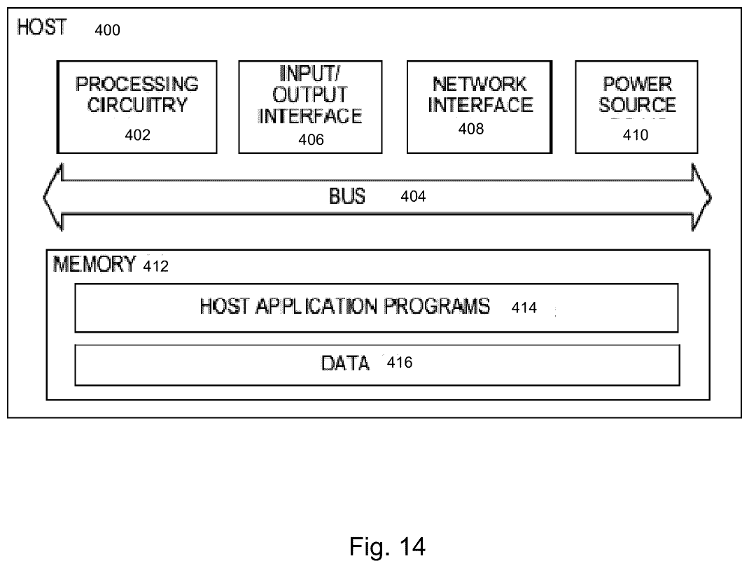

FIG. 14 is a block diagram of a host 400, which may be an embodiment of the host 116 of 1 FIG. 11, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

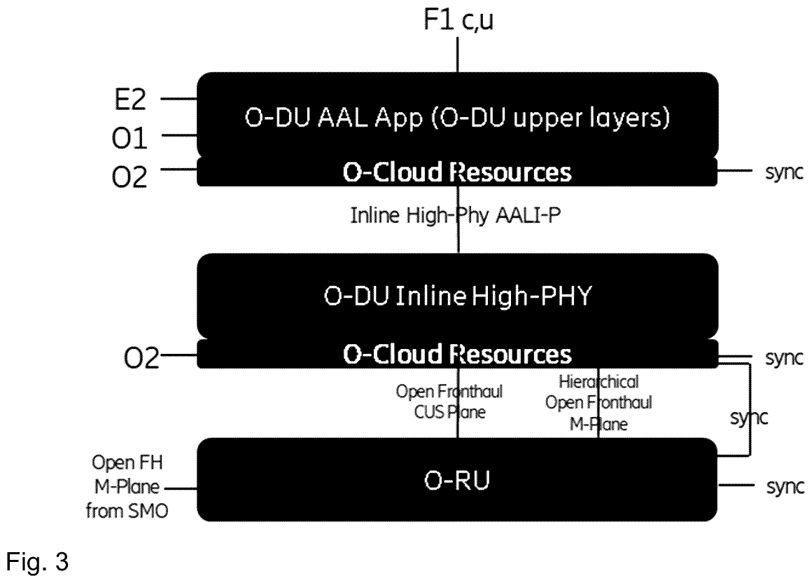

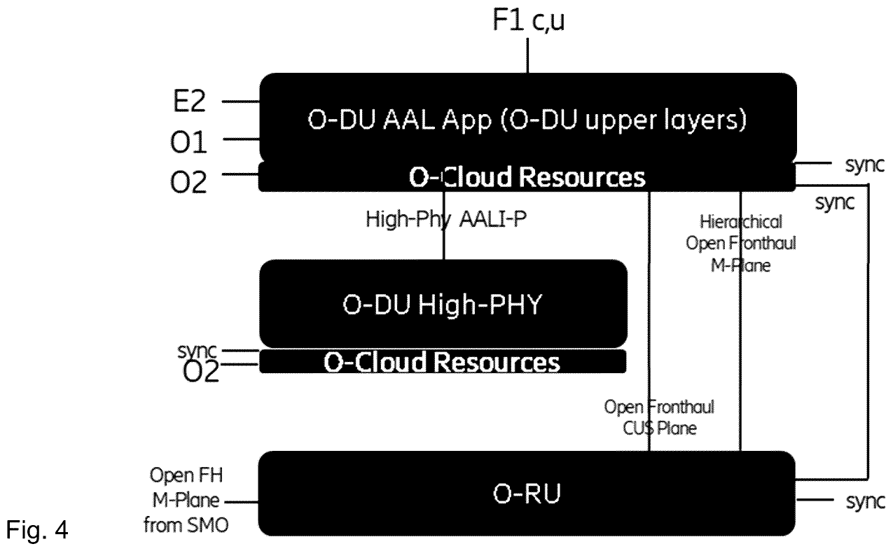

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

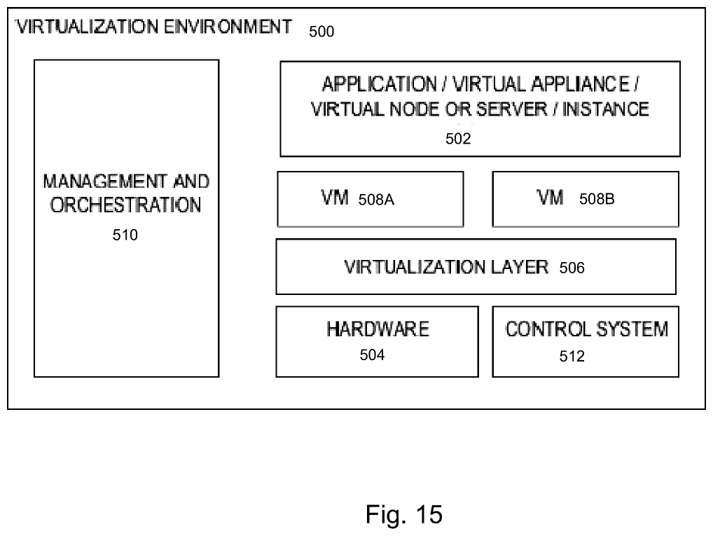

FIG. 15 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

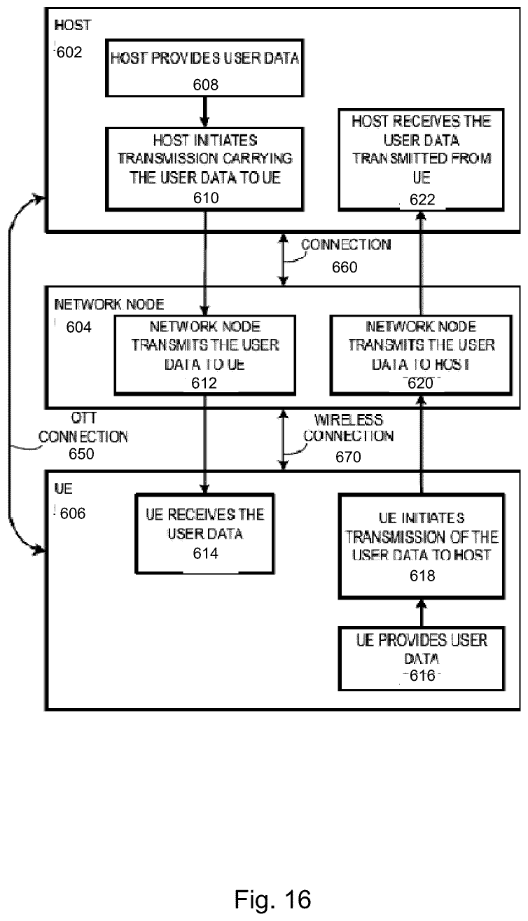

FIG. 16 shows a communication diagram of a host 602 communicating via a network node 604 with a UE 606 over a partially wireless connection in accordance with some embodiments. Example implementations, in accordance with various embodiments, of the UE (such as a UE 112a of FIG. 11 and/or UE 200 of FIG. 12), network node (such as network node 110a of FIG. 11 and/or network node 300 of FIG. 13), and host (such as host 116 of FIG. 11 and/or host 400 of FIG. 14) discussed in the preceding paragraphs will now be described with reference to FIG. 16.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 11) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

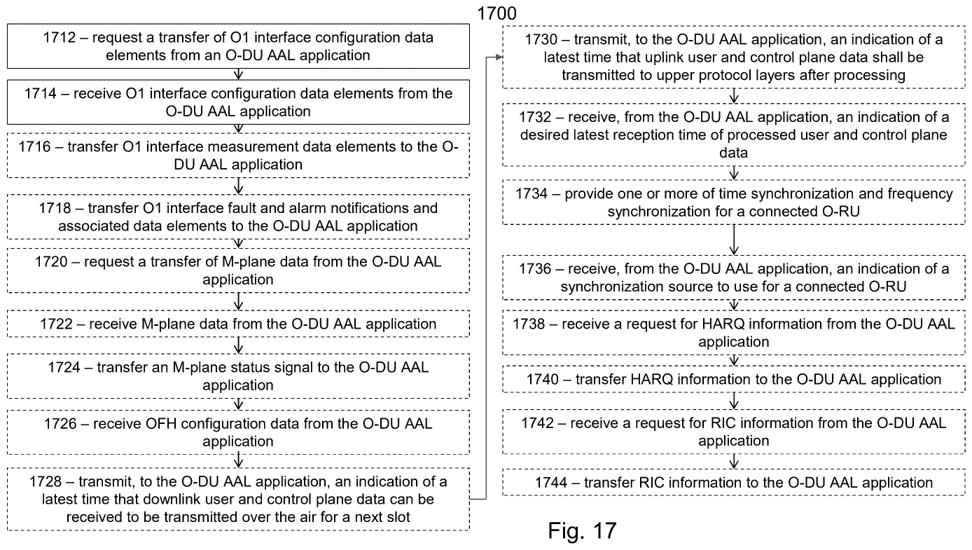

FIG. 17 is a flowchart illustrating an example method in a network node, according to certain embodiments. In particular embodiments, one or more steps of FIG. 17 may be performed by network node 300 described with respect to FIG. 13. The network node comprises an O-DU network node with a High-Phy AALI-P interface. The High-Phy AALI-P interface may be for one or more of an inline High-Phy profile and a look-aside High-Phy profile.

The method begins at step 1712, where the network node (e.g., network node 300) requests a transfer of O1 interface configuration data elements from an O-DU AAL application.

At step 1714, the network node receives O1 interface configuration data elements from the O-DU AAL application. Particular examples are described with respect to embodiments O1-1 and O1-2 above.

At step 1716, the network node transfers O1 interface measurement data elements to the O-DU AAL application. Transferring O1 interface measurement data elements may be initiated upon request, sent at defined time intervals, or may be continually streamed. Particular examples are described with respect to embodiments O1-3, O1-4, O1-5, O1-6 and O1-7 above.

At step 1718, the network node transfers O1 interface fault and alarm notifications and associated data elements to the O-DU AAL application. Particular examples are described with respect to embodiment O1-8 above.

At step 1720, the network node requests a transfer of M-plane data from the O-DU AAL application and at step 1722 the network node receives M-plane data from the O-DU AAL application. Particular examples are described with respect to embodiments M1 and M2 above.

At step 1724, the network node transfers an M-plane status signal to the O-DU AAL application. The M-plane status signal may comprise one or more of: a configuration status; a status of a connected O-RU; a status of a connected OFH; a format of M-plane data supported by the AALI-P; and a version of M-plane data supported by the AALI-P. Particular examples are described with respect to embodiments M3, M4, M5 and M7 above.

At step 1726, the network node receives OFH configuration data from the O-DU AAL application. Particular examples are described with respect to embodiment M8 above.

At step 1728, the network node transmits, to the O-DU AAL application, an indication of a latest time that downlink user and control plane data can be received to be transmitted over the air for a next slot. Particular examples are described with respect to embodiment T1 above.

At step 1730, the network node transmits, to the O-DU AAL application, an indication of a latest time that uplink user and control plane data shall be transmitted to upper protocol layers after processing. Particular examples are described with respect to embodiment T2 above.

At step 1732, the network node receives, from the O-DU AAL application, an indication of a desired latest reception time of processed user and control plane data. Particular examples are described with respect to embodiment T3 above.

At step 1734, the network node provides one or more of time synchronization and frequency synchronization for a connected O-RU. Particular examples are described with respect to embodiment S1 above.

At step 1736, the network node receives, from the O-DU AAL application, an indication of a synchronization source to use for a connected O-RU. Particular examples are described with respect to embodiment S2 above.

At step 1738, the network node receives a request for hybrid automatic repeat request (HARQ) information from the O-DU AAL application, and at step 1740 the network node transfers HARQ information to the O-DU AAL application. Particular examples are described with respect to embodiment G1 above.

At step 1742, the network node receives a request for radio access network intelligent controller (RIC) information from the O-DU AAL application, and at step 1744 the network node transfers RIC information to the O-DU AAL application. Particular examples are described with respect to embodiments E2-1, E2-2 and E2-3 above.

Modifications, additions, or omissions may be made to method 1700 of FIG. 17. Additionally, one or more steps in the method of FIG. 17 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.
1. A method performed by a O-DU node with a High-Phy AALI-P interface, the method comprising:
   supporting O-RAN O1 Interface and data collection according to any one of the embodiments O1-1 to O1-9 described above.
2. A method performed by a O-DU node with a High-Phy AALI-P interface, the method comprising:
   supporting signaling of O-RAN M-Plane information over the Inline High-Phy AALI-P interface according to any one of the embodiments M1 to M7 described above.
3. A method performed by a O-DU node with a High-Phy AALI-P interface, the method comprising:
   supporting O-RAN inline High-Phy AALI-P Interface support for the OFH Lower Layer Split according to embodiment M8 described above.
4. A method performed by a O-DU node with a High-Phy AALI-P interface, the method comprising:
   supporting allocation of O-DU User Plane processing times when an inline High-Phy AALI-P or High-Phy AALI-P interface is used according to any one of embodiments T1 to T3 described above.
5. A method performed by a O-DU node with a High-Phy AALI-P interface, the method comprising:
   supporting O-RAN synchronization plane with an O-RAN inline High-Phy AALI-P Interface according to any one of embodiments S1 to S8 described above.
6. A method performed by a O-DU node with a High-Phy AALI-P interface, the method comprising:
   performing any one of embodiments G1 to G3 described above.
7. A method performed by a O-DU node with a High-Phy AALI-P interface, the method comprising:
   supporting O-RAN E2 services and procedures according to any one of embodiments E2-1 to E2-3 described above.

### Group A Embodiments

8. A method performed by a wireless device, the method comprising:
   any of the wireless device steps, features, or functions described above, either alone or in combination with other steps, features, or functions described above.
9. The method of the previous embodiment, further comprising one or more additional wireless device steps, features or functions described above.
10. The method of any of the previous embodiments, further comprising:
   providing user data; and
   forwarding the user data to a host computer via the transmission to the base station.

### Group B Embodiments

11. A method performed by a base station, the method comprising:
   transmitting L4S congestion information to a user plane function (UPF).
12. A method performed by a base station, the method comprising:
   any of the steps, features, or functions described above with respect to base station, either alone or in combination with other steps, features, or functions described above.
13. The method of the previous embodiment, further comprising one or more additional base station steps, features or functions described above.
14. The method of any of the previous embodiments, further comprising:
   obtaining user data; and
   forwarding the user data to a host computer or a wireless device.

### Group C Embodiments

15. A mobile terminal comprising:
   processing circuitry configured to perform any of the steps of any of the Group A embodiments; and
   power supply circuitry configured to supply power to the wireless device.
16. A base station comprising:
   processing circuitry configured to perform any of the steps of any of the Group B embodiments;
   power supply circuitry configured to supply power to the wireless device.
17. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
18. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
19. The communication system of the pervious embodiment further including the base station.
20. The communication system of the previous 2 embodiments, further including the UE, wherein the UE is configured to communicate with the base station.
21. The communication system of the previous 3 embodiments, wherein:
   the processing circuitry of the host computer is configured to execute a host application, thereby providing the user data; and
   the UE comprises processing circuitry configured to execute a client application associated with the host application.
22. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
23. The method of the previous embodiment, further comprising, at the base station, transmitting the user data.
24. The method of the previous 2 embodiments, wherein the user data is provided at the host computer by executing a host application, the method further comprising, at the UE, executing a client application associated with the host application.
25. A user equipment (UE) configured to communicate with a base station, the UE comprising a radio interface and processing circuitry configured to performs any of the previous 3 embodiments.
26. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
27. The communication system of the previous embodiment, wherein the cellular network further includes a base station configured to communicate with the UE.
28. The communication system of the previous 2 embodiments, wherein:
   the processing circuitry of the host computer is configured to execute a host application, thereby providing the user data; and
   the UE's processing circuitry is configured to execute a client application associated with the host application.
29. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
30. The method of the previous embodiment, further comprising at the UE, receiving the user data from the base station.
31. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
32. The communication system of the previous embodiment, further including the UE.
33. The communication system of the previous 2 embodiments, further including the base station, wherein the base station comprises a radio interface configured to communicate with the UE and a communication interface configured to forward to the host computer the user data carried by a transmission from the UE to the base station.
34. The communication system of the previous 3 embodiments, wherein:
   the processing circuitry of the host computer is configured to execute a host application; and
   the UE's processing circuitry is configured to execute a client application associated with the host application, thereby providing the user data.
35. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
36. A method implemented in a communication system including a host computer, a base station and a user equipment (UE), the method comprising:
   at the host computer, receiving user data transmitted to the base station from the UE, wherein the UE performs any of the steps of any of the Group A embodiments.
37. The method of the previous embodiment, further comprising, at the UE, providing the user data to the base station.
38. The method of the previous 2 embodiments, further comprising:
   at the UE, executing a client application, thereby providing the user data to be transmitted; and
   at the host computer, executing a host application associated with the client application.
39. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
40. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
41. The communication system of the previous embodiment further including the base station.
42. The communication system of the previous 2 embodiments, further including the UE, wherein the UE is configured to communicate with the base station.
43. The communication system of the previous 3 embodiments, wherein:
   the processing circuitry of the host computer is configured to execute a host application;
   the UE is configured to execute a client application associated with the host application, thereby providing the user data to be received by the host computer.
44. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
45. The method of the previous embodiment, further comprising at the base station, receiving the user data from the UE.
46. The method of the previous 2 embodiments, further comprising at the base station, initiating a transmission of the received user data to the host computer.

1. A method performed by an open distributed unit (O-DU) network node with a High-Phy acceleration abstraction layer (AALI-P) interface, the method comprising:
requesting a transfer of O1 interface configuration data elements from an O-DU acceleration abstraction layer (AAL) application; and
receiving O1 interface configuration data elements from the O-DU AAL application.

2. The method of claim 1, further comprising transferring O1 interface measurement data elements to the O-DU AAL application.

3. The method of claim 2, wherein transferring O1 interface measurement data elements is initiated upon request, is sent at defined time intervals, or is continually streamed.

4. The method of claim 1, further comprising transferring O1 interface fault and alarm notifications and associated data elements to the O-DU AAL application.

5. The method of claim 1, further comprising:
requesting a transfer of M-plane data from the O-DU AAL application; and
receiving M-plane data from the O-DU AAL application.

6. The method of claim 1, further comprising transferring an M-plane status signal to the O-DU AAL application.

7. The method of claim 6, wherein the M-plane status signal comprises one or more of:
a configuration status;
a status of a connected open radio unit (O-RU);
a status of a connected open front haul network (OFH);
a format of M-plane data supported by the AALI-P; and
a version of M-plane data supported by the AALI-P.

8. The method of claim 1, further comprising receiving open front haul (OFH) configuration data from the O-DU AAL application.

9. The method of claim 1, further comprising transmitting, to the O-DU AAL application, an indication of a latest time that downlink user and control plane data can be received to be transmitted over the air for a next slot.

10. The method of claim 1, further comprising transmitting, to the O-DU AAL application, an indication of a latest time that uplink user and control plane data shall be transmitted to upper protocol layers after processing.

11. The method of claim 1, further comprising receiving, from the O-DU AAL application, an indication of a desired latest reception time of processed user and control plane data.

12. The method of claim 1, further comprising providing one or more of time synchronization and frequency synchronization for a connected open radio unit (O-RU).

13. The method of claim 1, further comprising receiving, from the O-DU AAL application, an indication of a synchronization source to use for a connected open radio unit (O-RU).

14. The method of claim 1, further comprising:
receiving a request for hybrid automatic repeat request (HARQ) information from the O-DU AAL application; and
transferring HARQ information to the O-DU AAL application.

15. The method of claim 1, further comprising:
receiving a request for radio access network intelligent controller (RIC) information from the O-DU AAL application; and
transferring RIC information to the O-DU AAL application.

16. An open distributed unit (O-DU) network node with a High-Phy acceleration abstraction layer (AALI-P) interface, the network node comprising processing circuitry operable to:
request a transfer of O1 interface configuration data elements from an O-DU acceleration abstraction layer (AAL) application; and
receive O1 interface configuration data elements from the O-DU AAL application.

17. The network node of claim 16, the processing circuitry further operable to transfer O1 interface measurement data elements to the O-DU AAL application.

18. The network node of claim 17, wherein the processing circuitry is operable to transfer O1 interface measurement data elements upon request, at defined time intervals, or continually streamed.

19. The network node of claim 16, the processing circuitry further operable to transfer O1 interface fault and alarm notifications and associated data elements to the O-DU AAL application.

20. The network node of claim 16, the processing circuitry further operable to:
request a transfer of M-plane data from the O-DU AAL application; and
receive M-plane data from the O-DU AAL application.

21. The network node of claim 16, the processing circuitry further operable to transfer an M-plane status signal to the O-DU AAL application.

22. The network node of claim 21, wherein the M-plane status signal comprises one or more of:
a configuration status;
a status of a connected open radio unit (O-RU);
a status of a connected open front haul network (OFH);
a format of M-plane data supported by the AALI-P; and
a version of M-plane data supported by the AALI-P.

23. The network node of claim 16 the processing circuitry further operable to receive open front haul (OFH) configuration data from the O-DU AAL application.

24. The network node of claim 16, the processing circuitry further operable to transmit, to the O-DU AAL application, an indication of a latest time that downlink user and control plane data can be received to be transmitted over the air for a next slot.

25. The network node of claim 16, the processing circuitry further operable to transmit, to the O-DU AAL application, an indication of a latest time that uplink user and control plane data shall be transmitted to upper protocol layers after processing.

26. The network node of claim 16, the processing circuitry further operable to receive, from the O-DU AAL application, an indication of a desired latest reception time of processed user and control plane data.

27.-30. (canceled)
